(19) United States
(12) Patent Application Publication
(10) Pub. No.: US 2026/0153974 A1
(43) Pub. Date: Jun. 4, 2026

(54) DISPLAY IMAGE CONTROL DEVICE AND DISPLAY IMAGE CONTROL METHOD

(71) Applicant: ASUSTEK COMPUTER INC., TAIPEI (TW)

(72) Inventors: Ya-Cuan CHENG, TAIPEI (TW); Jia-Jung KUO, TAIPEI (TW)

(21) Appl. No.: 19/085,159

(22) Filed: Mar. 20, 2025

(30) Foreign Application Priority Data
Dec. 4, 2024 (TW) 113147020

(51) Int. Cl. G06F 3/0484; G06F 3/0488

(52) U.S. Cl. CPC G06F 3/0484; G06F 3/0488; G06F 2203/04804

(57) ABSTRACT

A display image control device provided is applicable to an electronic device. The electronic device includes a touch display. The touch display is adapted to display an image. The display image control device includes an interface layer setting unit, a display area setting unit, and an interface layer state control unit. The interface layer setting unit is adapted to set an interface layer at an uppermost layer of the image in response to an enabling instruction. The display area setting unit is adapted to obtain a first touch trajectory through the interface layer. The first touch trajectory corresponds to a first area of the image. The interface layer state control unit is adapted to determine an area of shielding based on the first area, and change transparency of a part of the interface layer corresponding to the area of shielding. A display image control method is also provided.

### CROSS-REFERENCE TO RELATED APPLICATION

This application claims the priority benefit of Taiwan Application Serial No. 113147020, filed on Dec. 4, 2024. The entirety of the above-mentioned patent application is hereby incorporated by reference herein and made a part of specification.

### BACKGROUND OF THE INVENTION

### Field of the Invention

The disclosure relates to the field of display image control technologies, and in particular, to a display image control device and a display image control method.

### Description of the Related Art

Smartphones have become an indispensable tool in modern people's daily lives. However, when sharing an image of a mobile phone with others, a user often faces a problem that part of image content is inconvenient for others to see.

To resolve this problem, users often have to perform tedious operations to exclude the content that is inconvenient to present from the image. This not only wastes time, but also easily leads to leakage of sensitive information due to improper operation.

### BRIEF SUMMARY OF THE INVENTION

The disclosure provides a display image control device. The display image control device is applicable to an electronic device. The electronic device includes a touch display. The touch display is adapted to display an image. The display image control device includes an interface layer setting unit, a display area setting unit, and an interface layer state control unit. The interface layer setting unit is adapted to set an interface layer at an uppermost layer of the image in response to an enabling instruction. The display area setting unit is adapted to obtain a first touch trajectory through the interface layer. The first touch trajectory corresponds to a first area of the image. The interface layer state control unit is adapted to determine an area of shielding based on the first area, and change transparency of a part of the interface layer corresponding to the area of shielding.

The disclosure also provides a display image control method. The display image control device is applicable to an electronic device. The electronic device includes a touch display. The touch display is adapted to display an image. The display image control method includes the following steps. First, an interface layer is set at an uppermost layer of the image in response to an enabling instruction. Subsequently, a first touch trajectory is obtained through the interface layer. The first touch trajectory corresponds to a first area of the image. Next, an area of shielding is determined based on the first area. Then transparency of a part of the interface layer corresponding to the area of shielding is changed.

Through the display image control device and the display image control method provided in the disclosure, a user enables the interface layer through a simple and intuitive operation method, and inputs the first touch trajectory to determine the area of shielding. In this way, content that the user does not want to share in the image is quickly shielded, so as to protect personal privacy and share the image with peace of mind.

### BRIEF DESCRIPTION OF THE DRAWINGS

FIG. 1 is a schematic block diagram of a display image control device according to an embodiment of the disclosure;

FIG. 2 is a flowchart of a display image control method according to an embodiment of the disclosure;

FIG. 3 shows an embodiment of step S220 in FIG. 2;

FIG. 4 shows an embodiment of steps S260 and S280 in FIG. 2;

FIG. 5A to FIG. 5C show three embodiments of the first area defined in FIG. 2;

FIG. 6 shows another embodiment of steps S260 and S280 in FIG. 2;

FIG. 7 shows an embodiment of step S290 in FIG. 2;

FIG. 8 is a schematic block diagram of a display image control device according to another embodiment of the disclosure;

FIG. 9 is a flowchart of a display image control method according to another embodiment of the disclosure;

FIG. 10 shows a first embodiment of steps S950 and S960 in FIG. 9;

FIG. 11 shows a second embodiment of steps S950 and S960 in FIG. 9; and

FIG. 12 shows a third embodiment of steps S950 and S960 in FIG. 9.

### DETAILED DESCRIPTION OF THE EMBODIMENTS

Specific embodiments of the disclosure are described in more details below with reference to the schematic diagrams. Advantages and features of the disclosure are to be clearer based on the following descriptions and claims. It is to be noted that all the figures are in a very simple form and in an inaccurate proportion, and are merely intended to assist description of the purpose of the embodiments of the disclosure conveniently and clearly.

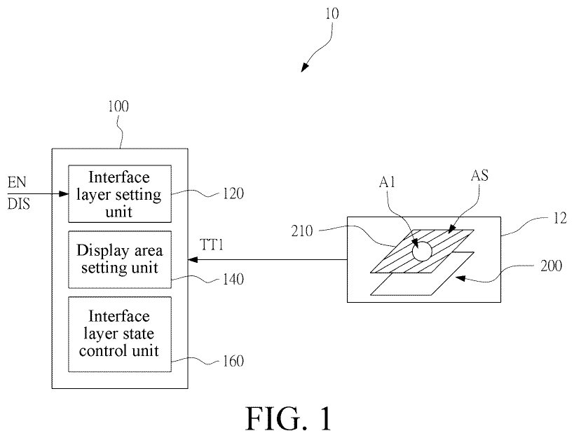

FIG. 1 is a schematic block diagram of a display image control device 100 according to an embodiment of the disclosure.

The disclosure provides a display image control device 100. The display image control device is applicable to an electronic device 10. The electronic device 10 includes a touch display 12. The touch display 12 is adapted to display an image 200. In an embodiment, the electronic device 10 is a portable electronic device, such as a smartphone, a tablet computer, and a notebook computer.

The display image control device 100 includes an interface layer setting unit 120, a display area setting unit 140, and an interface layer state control unit 160.

The interface layer setting unit 120 is adapted to set an interface layer 210 at an uppermost layer of the image 200 in response to an enabling instruction EN. In an embodiment, the interface layer setting unit 120 removes the interface layer 210 in response to a disabling instruction DIS.

The display area setting unit 140 is adapted to obtain a first touch trajectory TT1 through the interface layer 210. The first touch trajectory TT1 corresponds to a first area A1 of the image.

The interface layer state control unit 160 is adapted to determine an area of shielding AS based on the first area A1, and change transparency (opacity) of the interface layer 210 corresponding to the area of shielding AS.

In an embodiment, the area of shielding AS is all of the image 200 except the first area A1. However, the disclosure is not limited thereto.

In an embodiment, the interface layer state control unit 160 lowers the transparency of the part of the interface layer 210 corresponding to the area of shielding AS, so as to adjust the transparency from an opaque state with a transparency of 1 to a completely transparent state with a transparency of 0. In the opaque state, image content of the area of shielding AS is completely shielded by the interface layer 210.

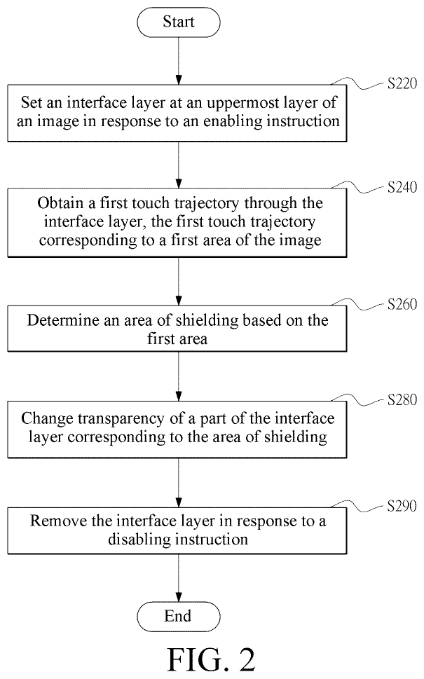

Refer to FIG. 2 together. FIG. 2 is a flowchart of a display image control method according to an embodiment of the disclosure. The display image control method is applicable to an electronic device 10. The electronic device 10 includes a touch display 12. The touch display 12 is adapted to display an image 200. The display image control method is used for the display image control device 100 shown in FIG. 1, including the following steps.

First, as described in step S220, a display image control mode is entered in response to an enabling instruction EN, and an interface layer 210 is set at an uppermost layer of the image 200. This step is performed by an interface layer setting unit 120.

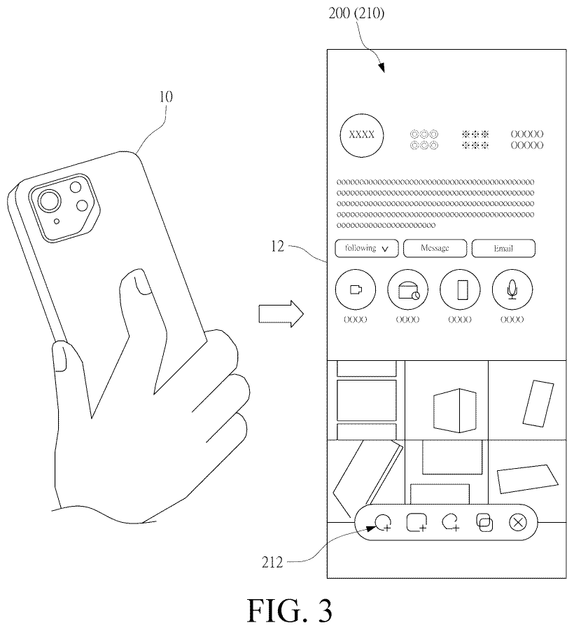

Refer to FIG. 3 together. FIG. 3 shows an embodiment of step S220 in FIG. 2.

As shown in the left half of the figure, a sensor (not shown in the figure) is arranged on a back cover of an electronic device 10 (such as a smartphone in the figure). A user inputs an enabling instruction EN by clicking the back cover of the electronic device 10. After receiving the enabling instruction EN, an interface layer setting unit 120 immediately presents an interface layer 210 on an image 200 of a touch display 12 on a front side of the electronic device 10.

The interface layer 210 is located at an uppermost layer of the image 200, to shield the user from touch control of another application program in the image 200. In an embodiment, as shown in the figure, a control area is set on the interface layer 210. The control area includes a plurality of control options 212 (only one of the control options is shown in the figure) for the user to select. In an embodiment, these control options 212 include an option of circling a selection, an option of ending display image control, and the like.

Subsequently, as described in step S240, a first touch trajectory TT1 is obtained through the interface layer 210. The first touch trajectory TT1 corresponds to a first area A1 of the image 200. In an embodiment, the first touch trajectory TT1 is a closed trajectory connected end to end. The first area A1 is an area surrounded by the first touch trajectory TT1. This step is performed by the display area setting unit 140.

Next, as described in step S260, an area of shielding AS is determined based on the first area A1. This step is performed by the interface layer state control unit 160.

Then as described in step S280, transparency of a part of the interface layer 210 corresponding to the area of shielding AS is changed.

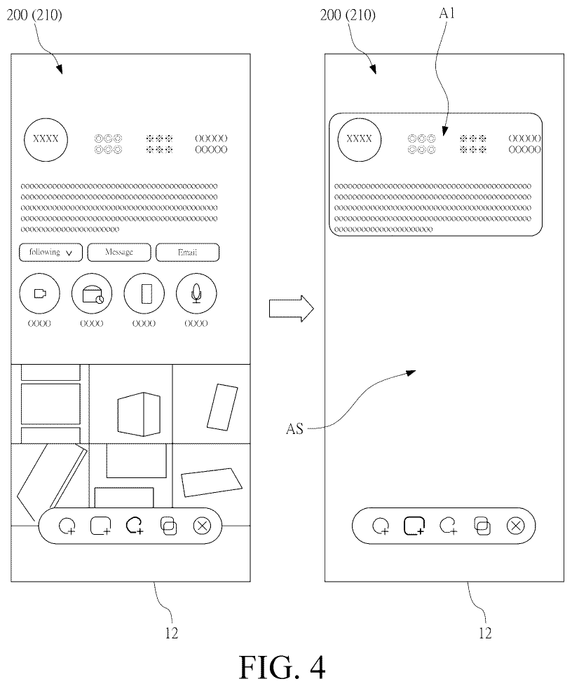

Refer to FIG. 4 together. FIG. 4 shows an embodiment of steps S260 and S280 in FIG. 2.

As shown in the figure, in this embodiment, a default state of the interface layer 210 is a transparent state. The interface layer state control unit 120 is adapted to convert a part of the interface layer corresponding to the area of shielding AS (that is, a part of the image except the first area A1) from the transparent state to a shielded state. The first area A1 is maintained in the transparent state. The first area A1 includes image content that the user wants to share.

Next, a color of the part of the interface layer 210 in the shielded state is set based on actual needs of the user. In an embodiment, the color of the part of the interface layer 210 in the shielded state is black or white.

In the display image control mode in the disclosure, a manner of defining the first area A1 is selected by clicking the control option 212 on the interface layer 210.

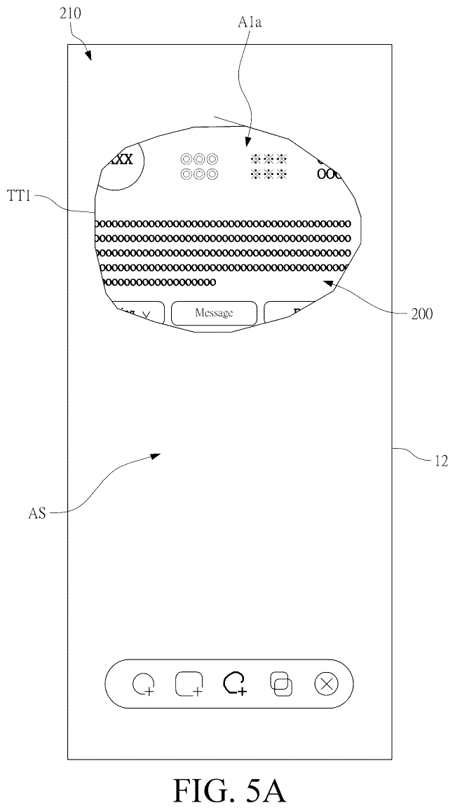

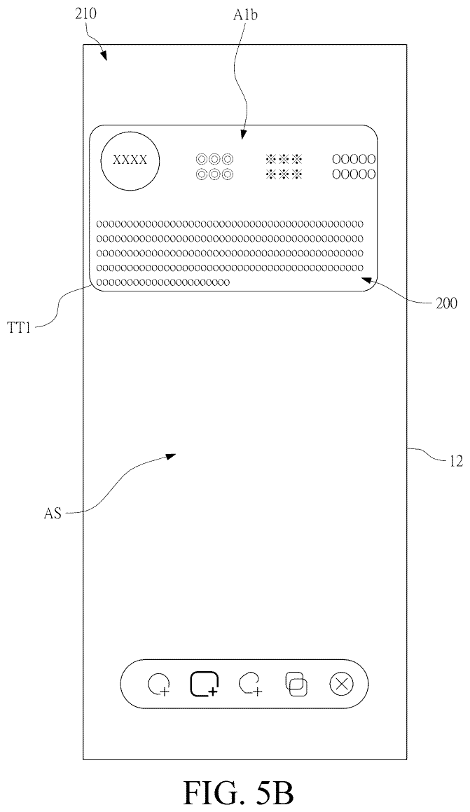

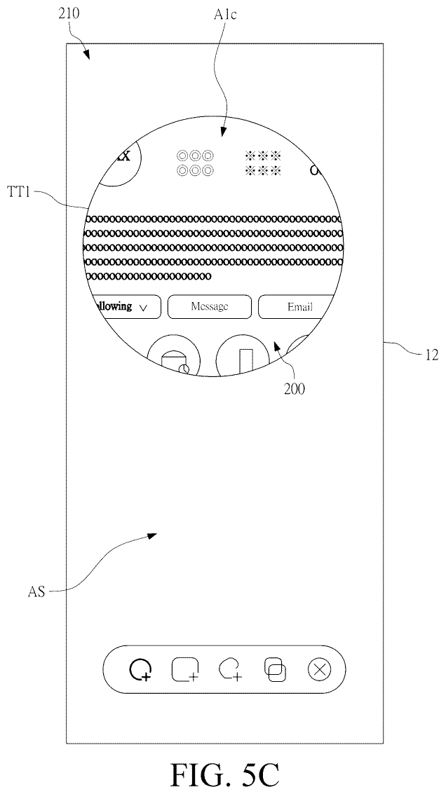

Refer to FIG. 5A to FIG. 5C together. FIG. 5A to FIG. 5C show three embodiments of defining the first area A1 in the disclosure.

In the embodiment shown in FIG. 5A, a first touch trajectory TT1 is a closed trajectory connected end to end. A first area A1a completely follows a direction of the first touch trajectory TT1, and is an area surrounded by the first touch trajectory TT1. The first area A1a is any pattern.

In the embodiment shown in FIG. 5B, a first area A1b is a square (or a rectangle) by default. A user inputs the first touch trajectory TT1 by touching. A display area setting unit 140 forms a corresponding square area as the first area A1b based on the first touch trajectory TT1.

Further, in an embodiment, the user further changes a position or a size of the first area A1b by dragging the square area (which is understood as the first touch trajectory TT1). Specifically, the user changes the position of the first area A1b by dragging a touch point inside the square area, and changes the size and a shape of the first area A1b by dragging a touch point except the square area.

In the embodiment shown in FIG. 5C, a first area A1c is a circle (or an ellipse) by default. The user inputs the first touch trajectory TT1 by touching. A display area setting unit 140 forms a corresponding circular area as the first area A1c based on the first touch trajectory TT1.

Further, in an embodiment, the user further changes a position or a shape of the first area A1c by dragging the circular area (which is understood as inputting the first touch trajectory TT1) by touching. Specifically, the user changes the position of the first area A1c by dragging a touch point inside the circular area, and changes a size and the shape of the first area A1c by dragging a touch point except the circular area.

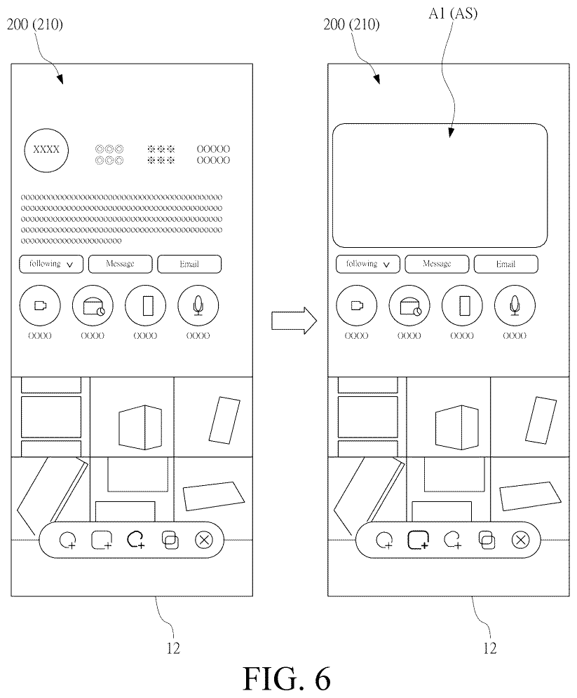

Refer to FIG. 6 together. FIG. 6 shows another embodiment of steps S260 and S280 in FIG. 2.

In the foregoing embodiment shown in FIG. 4, a default state of the interface layer 210 is a transparent state. The interface layer state control unit 120 determines an area except the first area A1 as the area of shielding AS, and converts the part of the interface layer 210 corresponding to the area of shielding AS (the part except the first area A1) from the transparent state to a shielded state.

In comparison, in this embodiment, the default state of the interface layer 210 is also the transparent state. However, the interface layer state control unit 120 regards the first area A1 as the area of shielding AS, and increases the transparency of the part of the interface layer 210 corresponding to the first area A1, so as to convert the part of the interface layer 210 corresponding to the first area A1 from the transparent state to the shielded state. Another part of the interface layer 210 is maintained in the transparent state. The first area A1 includes image content that the user does not want to share.

Finally, as described in step S290, a display image control mode is exited in response to a disabling instruction DIS, and the interface layer 210 is removed. In this case, an image 200 returns to an original unshielded state. This step is performed by an interface layer setting unit 120.

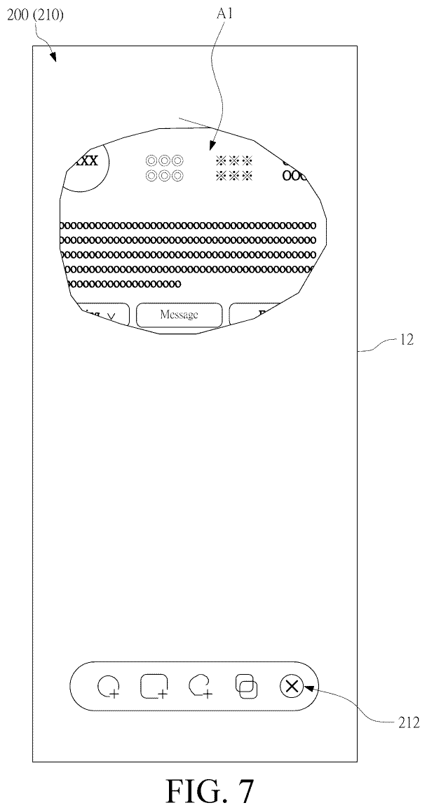

Refer to FIG. 7 together. FIG. 7 shows an embodiment of step S290 in FIG. 2.

As shown in the figure, control options 212 presented by the interface layer 210 include a disabling option (that is, the option “X” in the figure). The user generates a disabling instruction DIS by clicking the disabling option, to exit the display image control mode of the disclosure. However, the disclosure is not limited thereto. In another embodiment, the user also exits the display image control mode by using a default unlocking mode in the electronic device 10, such as a password, face recognition, a fingerprint, or a pattern.

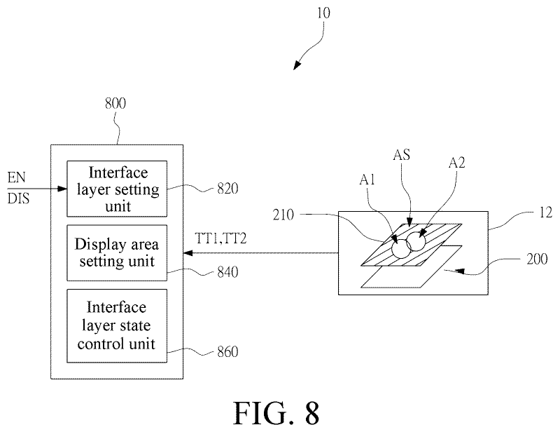

FIG. 8 is a schematic block diagram of a display image control device 800 according to another embodiment of the disclosure.

In the embodiment of FIG. 8, a display area setting unit 140 is adapted to obtain a first touch trajectory TT1 through an interface layer 210, to define a first area A1. An interface layer state control unit 160 determines an area of shielding AS based on the first area A1, and changes transparency of a part of the interface layer 210 corresponding to the area of shielding AS.

In comparison, the display area setting unit 840 of the display image control device 800 in this embodiment obtains a plurality of touch trajectories (such as a first touch trajectory TT1 and a second touch trajectory TT2) in sequence through the interface layer 210. These touch trajectories correspond to a plurality of different areas (such as the first area A1 and the second area A2). The interface layer state control unit 860 determines an area of shielding AS based on these areas (such as the first area A1 and the second area A2), and changes the transparency of the part of the interface layer 210 corresponding to the area of shielding AS.

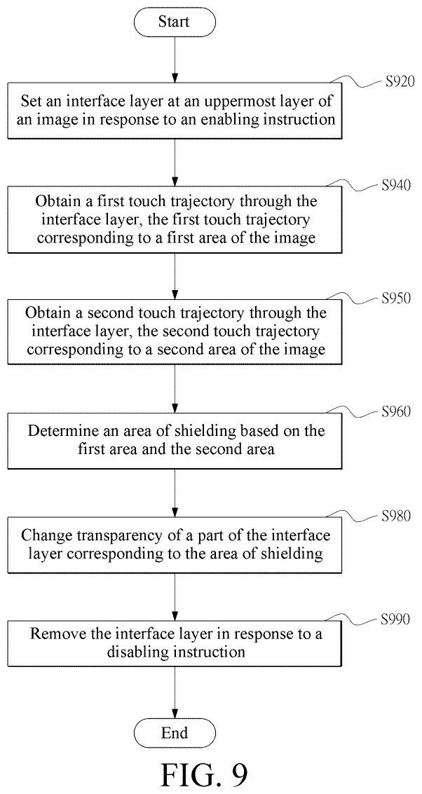

Refer to FIG. 9 together. FIG. 9 is a flowchart of a display image control method according to another embodiment of the disclosure. The display image control method is applicable to the display image control device 800 shown in FIG. 8. The display image control method includes the following steps.

First, as described in step S920, a display image control mode is entered in response to an enabling instruction EN, and an interface layer 210 is set at an uppermost layer of the image 200. This step is performed by an interface layer setting unit 820.

Subsequently, as described in step S940, a first touch trajectory TT1 is obtained through the interface layer 210. The first touch trajectory TT1 corresponds to a first area A1 of the image 200. This step is performed by the display area setting unit 840.

Next, as described in step S950, a second touch trajectory TT2 is obtained through the interface layer 210. The second touch trajectory TT2 corresponds to a second area A2 of the image 200. This step is performed by the display area setting unit 840.

Then as described in step S960, an area of shielding AS is determined based on the first area A1 and the second area A2. This step is performed by the interface layer state control unit 860.

Subsequently, as described in step S980, transparency of a part of the interface layer 210 corresponding to the area of shielding AS is changed. This step is performed by the interface layer state control unit 860.

Finally, as described in step S990, a display image control mode is exited in response to a disabling instruction DIS, and the interface layer 210 is removed. This step is performed by an interface layer setting unit 820.

The foregoing steps S920 and S990 are similar to the steps S220 and S290 in FIG. 2. Details are not described herein.

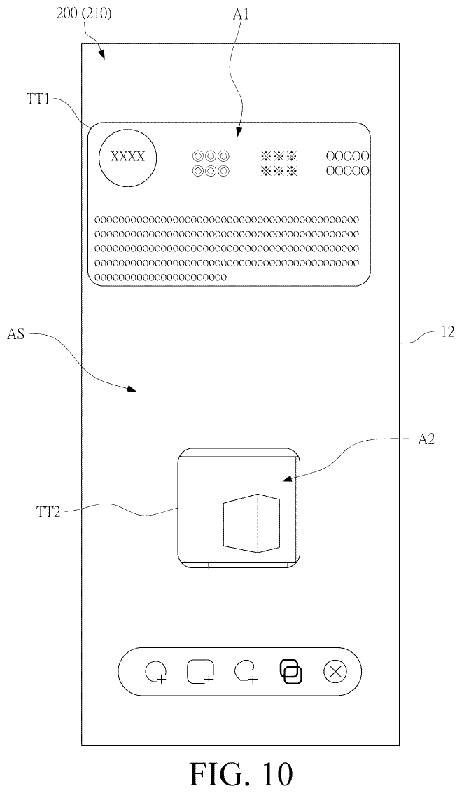

Refer to FIG. 10 together. FIG. 10 shows a first embodiment of steps S940 to S980 in FIG. 9.

In a case that the second area A2 does not overlap the first area A1, in this embodiment, the first area A1 and the second area A2 are regarded as two independent areas, a part of the image 200 except the first area A1 and the second area A2 is regarded as the area of shielding AS, and the transparency of the part of the interface layer 210 corresponding to the area of shielding AS is increased, so as to convert the transparency from a transparent state to a shielded state.

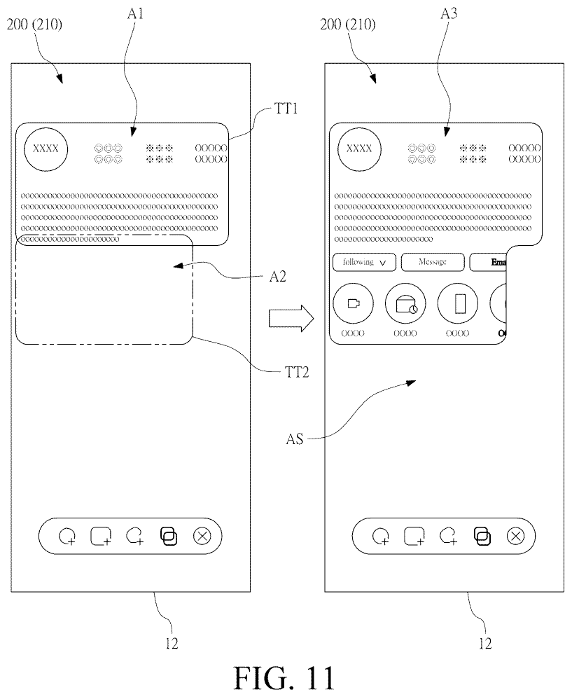

Refer to FIG. 11 together. FIG. 11 shows a second embodiment of steps S940 to S980 in FIG. 9.

In a case that the second area A2 overlaps the first area A1, in this embodiment, a third area A3 is generated by extending an outer contour of the first area A1 based on the second area A2, a part of the image 200 except the third area A3 is regarded as the area of shielding AS, and the transparency of the part of the interface layer 210 corresponding to the area of shielding AS is increased, so as to convert the transparency from a transparent state to a shielded state.

The third area A3 is regarded as a combination of the first area A1 and the second area A2. The operation is implemented through a “union” operation in the Boolean operation.

In the foregoing embodiment, the part except the third area A3 is regarded as the area of shielding AS. However, the disclosure is not limited thereto. In another embodiment, the third area A3 is also regarded as the area of shielding AS.

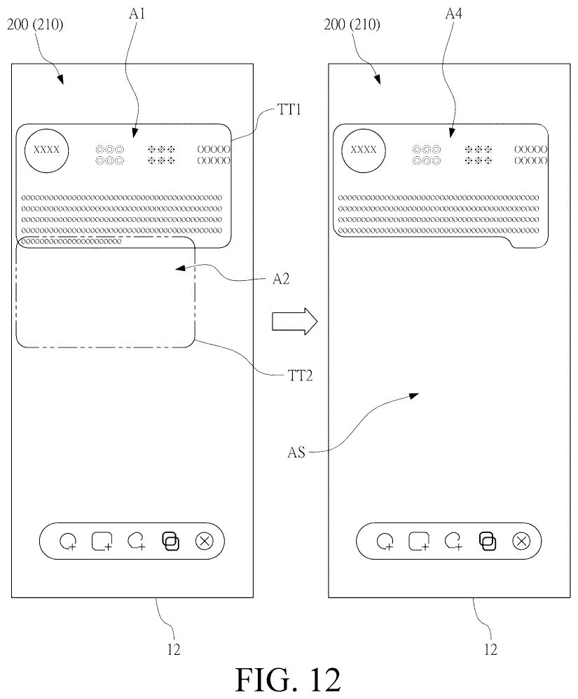

Refer to FIG. 12 together. FIG. 12 shows a third embodiment of steps S940 to S980 in FIG. 9.

In a case that the second area A2 overlaps the first area A1, in this embodiment, a fourth area A4 is generated by cutting an outer contour of the first area A1 based on the second area A2, a part of the image 200 except the fourth area A4 is regarded as the area of shielding AS, and the transparency of the part of the interface layer 210 corresponding to the area of shielding AS is increased, so as to convert the transparency from a transparent state to a shielded state.

The fourth area A4 is regarded as being formed by excluding the second area A2 from the first area A1. The operation is implemented through a “difference set” operation in the Boolean operation.

In the foregoing embodiment, the part except the fourth area A4 is regarded as the area of shielding AS. However, the disclosure is not limited thereto. In another embodiment, the fourth area A4 is also regarded as the area of shielding AS.

Further, in an embodiment, a user also controls a display image control device 800 to adopt an area division manner of the foregoing embodiments by clicking a control option on the interface layer 210.

It is to be noted that the foregoing embodiments of FIG. 10 to FIG. 12 describe a display image control manner in a case that two touch trajectories (that is, a first touch trajectory TT1 and a second touch trajectory TT2) corresponding to two different areas (that is, the first area A1 and the second area A2) are obtained. However, the disclosure is not limited thereto. The display image control device 800 and the display image control method in the disclosure are also applicable to a usage scenario of obtaining more touch trajectories. In an embodiment, if three touch trajectories are obtained and divided into three areas, the three areas are regarded as independent areas to determine a part of the interface layer 210 that needs transparency adjustment. Further, if these areas overlap, the part of the interface layer 210 which needs the transparency adjustment is also determined based on the foregoing principle, that is, by finding a union or a difference of these areas.

Through the display image control device 100, 800 and the display image control method provided in the disclosure, a user enables the interface layer 210 through a simple and intuitive operation method, and inputs the first touch trajectory TT1 to determine the area of shielding AS. In this way, content that the user does not want to share in the image 200 is quickly shielded, so as to protect personal privacy and share the image 200 with peace of mind.

The above descriptions are merely preferred embodiments of the disclosure, and do not impose any limitation on the disclosure. Any form of change such as an equivalent replacement or modification made by any person skilled in the art to technical means and technical content disclosed in the disclosure without departing from scope of the technical means of the disclosure is content that does not deviate from the technical means of the disclosure, and still falls within protection scope of the disclosure.

What is claimed is:

1. A display image control device, applicable to an electronic device, wherein the electronic device comprises a touch display, the touch display is adapted to display an image, and the display image control device comprises:
an interface layer setting unit, adapted to set an interface layer at an uppermost layer of the image in response to an enabling instruction;
a display area setting unit, adapted to obtain a first touch trajectory through the interface layer, wherein the first touch trajectory corresponds to a first area of the image; and
an interface layer state control unit, adapted to determine an area of shielding based on the first area, and change transparency of a part of the interface layer corresponding to the area of shielding.

2. The display image control device according to claim 1, wherein a default state of the interface layer is a transparent state, and the interface layer state control unit regards a part of the image except the first area as the area of shielding.

3. The display image control device according to claim 1, wherein a default state of the interface layer is a transparent state, and the interface layer state control unit regards the first area as the area of shielding.

4. The display image control device according to claim 1, wherein after obtaining the first touch trajectory, the display area setting unit is adapted to obtain a second touch trajectory through the interface layer, the second touch trajectory corresponds to a second area of the image, and the interface layer state control unit is adapted to determine the area of shielding based on the first area and the second area.

5. The display image control device according to claim 4, wherein when the second area overlaps the first area, the display area setting unit generates a third area by extending an outer contour of the first area based on the second area, and the interface layer state control unit regards a part of the image except the third area as the area of shielding.

6. The display image control device according to claim 4, wherein when the second area overlaps the first area, the display area setting unit generates a fourth area by cutting the outer contour of the first area based on the second area, and the interface layer state control unit regards a part of the image except the fourth area as the area of shielding.

7. The display image control device according to claim 1, wherein the first area is square, circular, or rectangular in shape.

8. The display image control device according to claim 1, wherein the interface layer setting unit is adapted to remove the interface layer in response to a disabling instruction.

9. A display image control method, applicable to an electronic device, wherein the electronic device comprises a touch display, the touch display is adapted to display an image, and the display image control method comprises:
setting an interface layer at an uppermost layer of the image in response to an enabling instruction;
obtaining a first touch trajectory through the interface layer, wherein the first touch trajectory corresponds to a first area of the image;
determining an area of shielding based on the first area; and
changing transparency of a part of the interface layer corresponding to the area of shielding.

10. The display image control method according to claim 9, wherein a default state of the interface layer is a transparent state, and the step of determining the area of shielding based on the first area is regarding a part of the image except the first area as the area of shielding.

11. The display image control method according to claim 9, wherein a default state of the interface layer is a transparent state, and the step of determining the area of shielding based on the first area is regarding the first area as the area of shielding.

12. The display image control method according to claim 9, further comprising:
obtaining a second touch trajectory through the interface layer, wherein the second touch trajectory corresponds to a second area of the image.

13. The display image control method according to claim 12, wherein the step of determining the area of shielding based on the first area comprises:
generating a third area by extending an outer contour of the first area based on the second area; and
regarding a part of the image except the third area as the area of shielding.

14. The display image control method according to claim 12, wherein the step of determining the area of shielding based on the first area comprises:
generating a fourth area by cutting an outer contour of the first area based on the second area; and
regarding a part of the image except the fourth area as the area of shielding.

15. The display image control method according to claim 9, further comprising:
removing the interface layer in response to a disabling instruction.
